(19) United States
(12) Patent Application Publication
(10) Pub. No.: US 2020/0045234 A1
(43) Pub. Date: Feb. 6, 2020

(54) IMAGE DISPLAY METHOD, IMAGE DISPLAY SYSTEM AND VIRTUAL WINDOW

(71) Applicants: LITE-ON ELECTRONICS (GUANGZHOU) LIMITED, Guangzhou (CN); Lite-On Technology Corporation, Taipei (TW)

(72) Inventors: Shou-Te Wei, Taipei (TW); Wei-Chih Chen, Taipei (TW)

(73) Assignees: LITE-ON ELECTRONICS (GUANGZHOU) LIMITED, Guangzhou (CN); Lite-On Technology Corporation, Taipei (TW)

(21) Appl. No.: 16/215,672

(22) Filed: Dec. 11, 2018

(30) Foreign Application Priority Data
Aug. 2, 2018 (CN) 201810871217.8

(51) Int. Cl. H04N 5/232; G09G 3/00

(52) U.S. Cl. CPC H04N 5/23299; G09G 3/003; H04N 5/23238

(57) ABSTRACT

An image display system including a display, a positioning device, an image capturing device and a processor is provided. The positioning device determines a viewing direction according to a positional relationship of the display and a reference object, the image capturing device acquires an image according to the viewing direction and a position parameter, and the display displays the image. In addition, an image display method and a virtual window are also provided.

### CROSS-REFERENCE TO RELATED APPLICATION

This application claims the priority benefit of China application serial no. 201810871217.8, filed on Aug. 2, 2018. The entirety of the above-mentioned patent application is hereby incorporated by reference herein and made a part of this specification.

### TECHNICAL FIELD

The invention relates to an image display technology, and in particular, to an image display method, an image display system and a virtual window.

### BACKGROUND

Generally, when selling a pre-sale house, the company often sets up an exhibition center or reception center to show the customer the environment, construction method or internal and external space of the house, etc. However, in many cases, the location of the exhibition center or the reception center is not located at the base of the pre-sale house. Therefore, even if a luxurious interior can be established in the reception center, it is also impossible for customers to learn the actual external environment of the pre-sale house after completion.

In addition, even if the location of the reception center is located at the base of the pre-sale house, the reception center is usually temporary and not high. Therefore, the customer still cannot learn the scenery outside the window of the pre-sale house after the completion of the building.

### SUMMARY

In view of the foregoing, embodiments of the invention provide an image display method, an image display system and a virtual window can simulate the window view seen at a specified observation point.

An aspect of the invention provides an image display system including a display, a positioning device, an image capturing device, and a processor. The display, the positioning device, and the image capturing device are all coupled to the processor. The positioning device determines a viewing direction according to a positional relationship between the display and a reference object, the image capturing device captures images according to the viewing direction and a positional parameter, and the display shows the image.

Another aspect of the invention provides an image display method applicable to an image display system including a display, a positioning device, and an image capturing device. The image display method includes: determining, by the positioning device, a viewing direction according to a positional relationship between the display and a reference object; capturing, by the image capturing device, an image according to the viewing direction and a position parameter; and displaying, by the display, the image.

Yet another aspect of the invention provides a virtual window for simulating a window view corresponding observation point. The virtual window includes a display, a positioning device, an image capturing device, and a processor, where the display, the positioning device and the image capturing device are all coupled to the processor. The positioning device determines a viewing direction according to a positional relationship between the display and a reference object, the image capturing device captures an image according to the viewing direction at an observation point, and the display displays the image to simulate the window view.

Based on the above, the image display method, the image display system and the virtual window provided by embodiments of the invention, utilize a positioning device to determine the viewing direction of the user viewing the display, and utilize an image capturing device located at the observation point to obtain an image corresponding to the viewing direction, and display the image on the display. As such, it is capable of simulating the window view seen by the user who is located at the observation point.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a block diagram of an image display system according to an embodiment of the invention.

FIG. 2A, FIG. 2B and FIG. 2C are schematic diagrams of a usage scenario of an image display system according to an embodiment of the invention.

FIG. 3 is a flow chart of an image display method according to an embodiment of the invention.

FIG. 4A and FIG. 4B are schematic diagrams of displaying an image on a display according to an embodiment of the invention.

### DESCRIPTION OF THE EMBODIMENTS

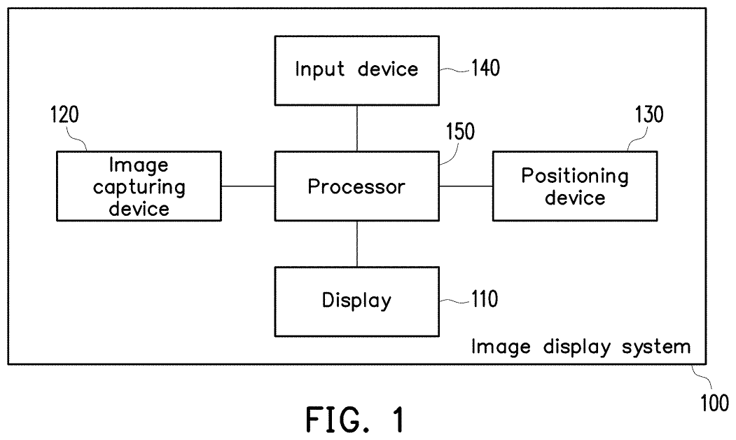

FIG. 1 is a block diagram of an image display system according to an embodiment of the invention.

Referring to FIG. 1, an image display system 100 includes a display 110, an image capturing device 120 (also referred to as a first image capturing device 120), a positioning device 130, an input device 140, and a processor 150 coupled to each of the aforementioned components in a wired or wireless manner (also referred to as a first processor 150). By cooperation of the above components, in some embodiments, the display 110 can be used as a virtual window. The system may specify a designated observation point and a viewing direction according to a positional relationship between a user and the display 110 and a position parameter, then present a window view that can be seen along the viewing direction when the user is at the designated observation point.

The display 110 includes a plurality of display pixels, which is, for example, a Liquid-Crystal Display (LCD), a Light-Emitting Diode (LED) display, or other suitable type of display, configured to display 2D or 3D images, but which is not limited in the invention. In some embodiments, the display 110 is, for example, implemented as an appearance of a window, and configured to display the simulated window view.

The image capturing device 120 is, for example, various cameras such as traditional cameras or full-view cameras, configured to capture images in their field of view, but which is not limited in the invention. In some embodiments, the image capturing device 120 is, for example, implemented in a drone, remotely controlled by the first processor 150 through a wireless transceiver module (not shown) and capable of moving to the designated observation point to acquire an image there. In other embodiments, the image capturing device 120 can also be, for example, a surveillance camera for security monitoring.

The positioning device 130 is configured to determine the viewing direction that the display 110 is being viewed according to a position of the display 110. Specifically, when the user views the display 110 from a different location, the viewing direction of the display 110 viewed by the user is different. Therefore, the positioning device 130 determines the viewing direction when the user views the display 110 according to the relative positional relationship between the user and the display 110.

In some embodiments, the positioning device 130 is implemented by, for example, a plurality of image capturing devices (also referred to as second image capturing devices), and the second image capturing devices are coupled to a processor (also referred to as a second processor). The plurality of second image capturing devices are, for example but not limited to, various cameras such as traditional cameras or full-view cameras, set in different positions to get multiple images in different fields of view. If the images in different fields of view obtained by the second image capturing device includes the user and the setting position of the display 110 is known, the second processor can calculate the position of the user according to the set positions of the second image capturing devices, then calculate the view direction of the display 110 viewed by the user according to the position of the user and the set position of the display 110. On the other hand, if the images in different fields of view obtained by the second image capturing devices include both the user and the display 110, then regardless of whether the setting position of the display 110 is known, the second processor can also calculate the viewing direction of the display 110 viewed by the user from the images. It is worth mentioning that, a person skilled in the art may realize the way the second processor calculates the viewing direction based on the knowledge of geometric mathematics, which is not described herein and the details of the calculation is not limited herein.

In other embodiments, the positioning device 130 can also be implemented by, for example, a single second image capturing device, a direction sensor, and a second processor coupled to the second image capturing device and the direction sensor. The direction sensor is, for example but not limited to, a nine-axis sensor or a gyroscope, etc., configured to obtain the current direction of the second image capturing device (e.g., the orientation of the lens). As such, if the second image capturing device is worn by the user, as long as the image captured by the second image capturing device includes the display 110, the second processor is capable of knowing the positional relationship between the user and the display 110 and calculating the viewing direction of the display 110 viewed by the user, on the basis of a position of the display 110 in the image and the current direction of the second image capture device. It is worth mentioning that, a person skilled in the art may realize the way the second processor calculates the viewing direction based on the knowledge of geometric mathematics, which is not described herein and the details of the calculation is not limited herein.

It is worth mentioning that, the second processor of the positioning device 130 may be a dedicated processor of the positioning device 130 and may be independent from the first processor 150. On the other hand, the second processor and the first processor 150 can also be implemented as the same one processor, but the invention is not limited thereto.

The input device 140 is, for example, a keyboard, a mouse, a microphone, or a touch device, configured to receive an input signal corresponding to the position parameter, however, the invention is not limited thereto. In some embodiments, the input device 140 is, for example, implemented in a form of a remote controller. The user can use the remote controller to input the position parameter, so as to wirelessly select the observation point corresponding to the scene that the user wishes to see in display 110. In other embodiments, the input device 140 is, for example, integrated with the display 110 as a touch screen, allowing the user to input the position parameter by touching the touch screen, so as to select the observation point corresponding to the scene that the user wishes to see in the display 110. For example, when the user wishes to see the view on the 21st floor in the display 110 which is implemented as the appearance of the window, the user can input the position parameter corresponding to the 21st floor through the input device 140, so as to select the 21st floor as the observation point.

The processor 150 is, for example, a central processing unit (CPU), or other programmable general purpose or special purpose microprocessor, a digital signal processor (DSPs), a programmable controller, and an application specific integrated circuits (ASIC), a programmable logic device (PLD) or other similar device or a combination of these devices, responsible for the overall operation of the image display system 100, to complete the image display method of the embodiment of the invention.

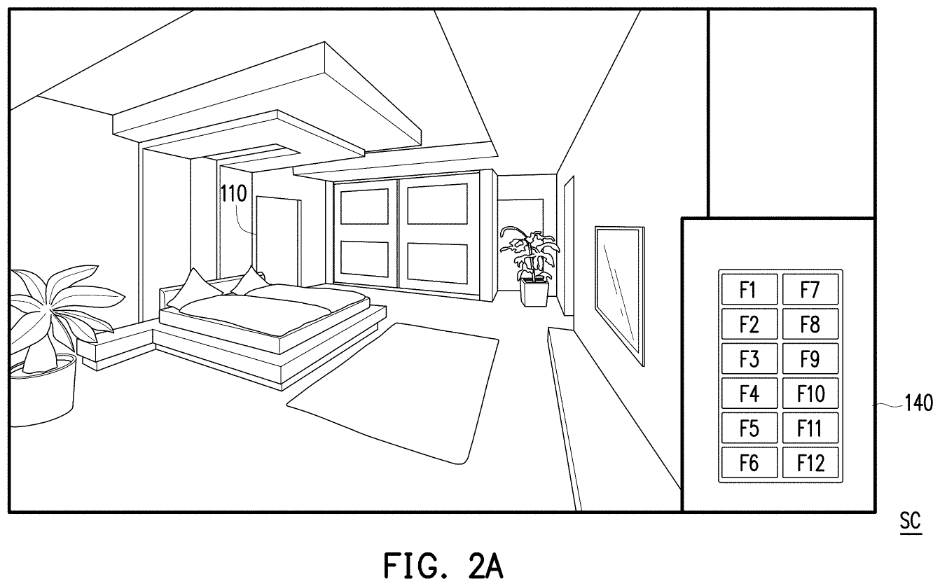

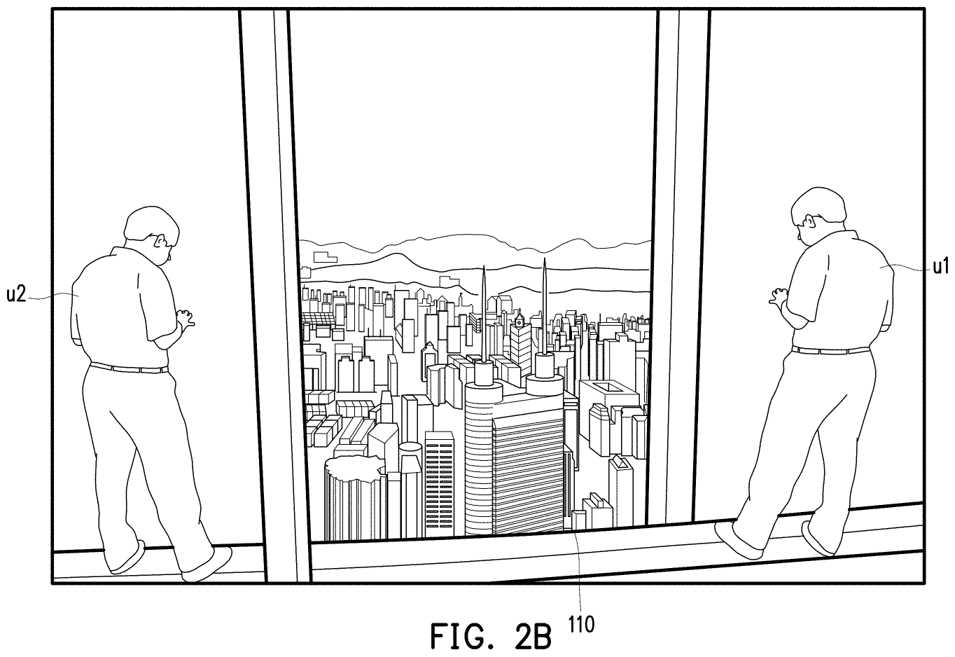

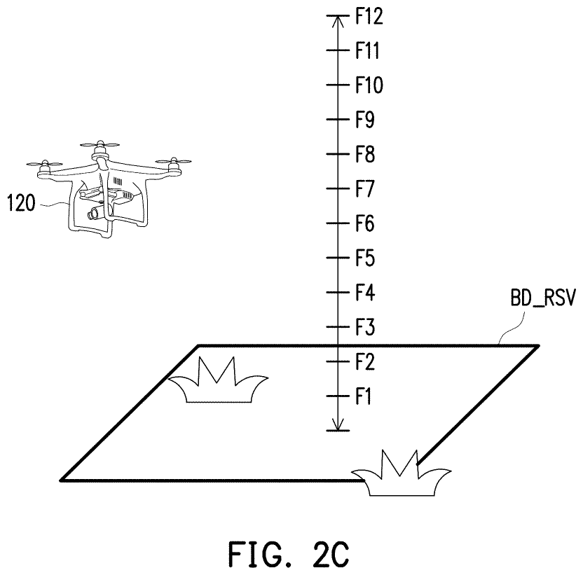

FIGS. 2A-2C are schematic diagrams of a usage scenario of an image display system according to an embodiment of the invention.

In an embodiment of the invention, as shown in FIG. 2A, the image display system 100 is, for example, applied to an exhibition center SC of a pre-sale house. The exhibition center SC includes, for example, an indoor sample model of the pre-sale house, wherein the display 110 is disposed at the window position and it simulates and displays the window view for users. In addition, the input device 140 is also provided to the users for operation.

In detail, when the relative position between the user and the window is different, the scenery that user sees will also be different. As shown in FIG. 2B, although the scenery outside the window does not change, but what the user sees at position u1 and position u2 will not be the same when the user is viewing the window. For example, the user at position u1 sees the scenery in the northeast from the window, and the user at position u2 sees the scenery in the northwest from the window. In addition, the exhibition center SC is generally a temporary construction for selling the pre-sale house, and the actual building of the pre-sale house has not been completed. Therefore, in the exhibition center SC, it is impossible to see the scenery outside the window of the pre-sale house located in the reserved location of the building BD_RSV.

Accordingly, as shown in FIG. 2C, the image display system 100 in an embodiment of the invention implements the image capturing device 120 as a drone, makes it reach the designated observation point (e.g., designated one of the floors F1 to F12 of the reserved location of the building BD_RSV) to capture the scene of the observation point, and implements the display 110 as a sample window in the exhibition center SC. The display 110 displays the window view corresponding to the designated observation point (e.g., designated one of the floors F1 to F12) according to the viewing direction that the user watches of the window.

It is worth mentioning that, the image display system 100 provided by the invention is not limited to the application of the embodiments of FIG. 2. One skilled in the art can apply the image display system of the invention according to his/her needs. Details of the steps of the image display method used in the image display system will be described in embodiments below.

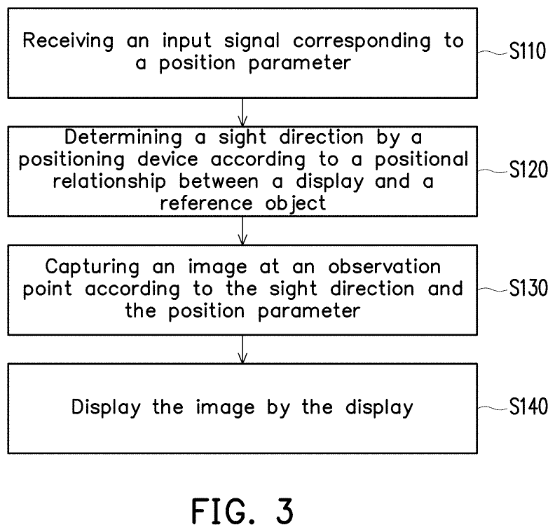

FIG. 3 is a flow chart of an image display method according to an embodiment of the invention.

The image display method in embodiments of FIG. 3 can be cooperatively completed by the components of the image display system 100 in the embodiments of FIG. 1, therefore, the image display method of the embodiments of FIG. 3 will be described below by referring to various components of the image display system 100.

Referring to FIG. 3, in step S110, the input device 140 receives an input signal corresponding to a position parameter, and the processor 150 selects an observation point according to the input signal.

Taking the embodiments of FIGS. 2A to 2C as an example, the user may input the floor at which the window view he/she wants to see through the input device 140 at the exhibition center SC of the pre-sale house, wherein the input signal, for example, corresponds to the position parameter such as floor information. The processor 150 selects the observation point according to the input signal, that is at a height of the floor of the reserved location of the building BD_RSV corresponding to the above floor information.

In step S120, the image display system 100 determines the viewing direction according to the positional relationship between the display 110 and a reference object through the positioning device 130. In some embodiments, the reference object is, for example, the user viewing the display 110.

As described in the previous paragraphs, in some embodiments, the positioning device 130 can obtain multiple images in different fields of view by using a plurality of second image capturing devices, for example. When the user is included in the images and the setting position of the display 110 is known, the second processor can calculate the position of the user based on the images, then calculate the viewing direction further based on the position of the display 110. On the other hand, when such images include both the user and the display 110, then regardless of whether the setting position of the display 110 is known, the second processor is capable of calculating the viewing direction that the user views the display 110 according to the images and the position of the display 110.

In other embodiments, the positioning device 130 obtains the second image including the display 110 by, for example, a second image capturing device worn by the user, and obtains the current direction of the second image capturing device by using a direction sensor. As such, the second processor is capable of knowing the positional relationship between the user and the display 110 and calculating the viewing direction that the user views the display 110 according to the position of the display 110 in the second image and the current direction of the second image capturing device.

In some embodiments, display 110 includes multiple pixels. Assuming that the head or centroid is taken as the viewing reference point REF, the viewing direction that the user views the display 110 can be represented, for example, by the connection direction between the viewing reference point REF and each pixel of the display 110. For example, the above-mentioned connection direction can be represented by two parameters of the polar angle (θ) and the azimuth angle (φ) in the conventional spherical coordinate system.

In step S130, the image display system 100 captures an image at the observation point according to the viewing direction and the position parameter by the first image capturing device 120, and in step S140, the display 110 displays the image.

Taking the embodiments of FIGS. 2A to 2C as an example, the processor 150 first controls the first image capturing device 120 that is implemented as a drone to move to the observation point, that is, at a height of the floor the reserved location of the building BD_RSV corresponding to the input signal. Subsequently, the first image capturing device 120 obtains an image corresponding to the viewing direction at the observation point.

In detail, the first image capturing device 120 obtains an image in the connection direction between the viewing reference point REF and each pixel of the display 110 at the observation point. For example, the connection direction between the viewing reference point REF and the first pixel of the display 110 is directed to the east and parallel to the horizontal plane, then the first image capturing device 120 obtains a pixel image that faces the east and is parallel to the horizontal plane at the observation point. For another example, the connection direction between the viewing reference point REF and the second pixel of the display 110 is directed 1 degree southward from the east and parallel to the horizontal plane, then the first image capturing device 120 obtains a pixel image that is 1 degree southward from the east and parallel to the horizontal plane at the observation point, and so on. As such, the image acquired by the first image capturing device 120 can be simulated as a window view seen by the user who is located at the observation point when the image is displayed on the display 110.

In some embodiments, the first image capturing device 120 is not a full-view camera, so after moving to the observation point, the processor 150 further rotates the first image capturing device 120 according to the viewing direction, such that the first image capturing device 120 can be made to obtain an image corresponding to the viewing direction.

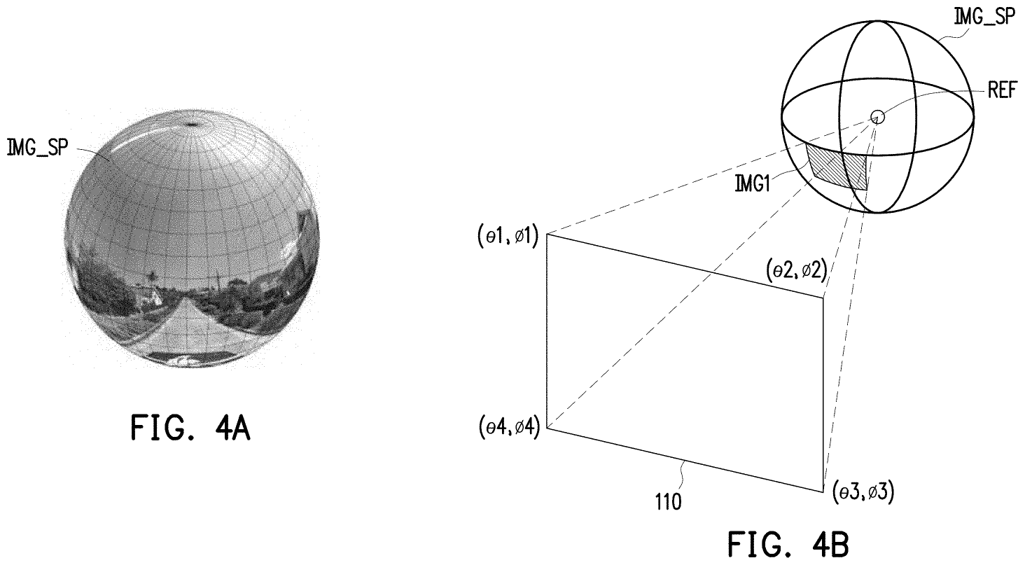

FIGS. 4A and 4B are schematic diagrams of displaying an image on a display according to an embodiment of the invention.

In some embodiments, the first image capturing device 120 is a full-view camera, therefore, for example, a full-view image IMG_sp as shown in FIG. 4A can be captured at the observation point. The full-view image IMG_sp is a two-dimensional spherical image, wherein the spherical coordinates can be expressed, for example, by the polar angle θ and the azimuth angle φ, wherein 0≤0≤π, and 0≤φ≤2π. The processor 150 then selects an image corresponding to the viewing direction from the full-view image IMG_sp, and displays it on the display 110.

In detail, the processor 150 obtains a pixel image of the full-view image IMG_sp corresponding to the connection direction between the viewing reference point REF and each pixel of the display 110, and displays the pixel images on the display 110.

Referring to FIG. 4B, the connection direction between the viewing reference point REF and the pixel at the upper leftmost corner of the display 110 can be expressed as (θ1, φ1), the connection direction between the viewing reference point REF and the pixel at the upper rightmost corner of the display 110 can be expressed as (θ2, φ2), the connection direction between the viewing reference point REF and the pixel at the lower rightmost corner of the display 110 can be expressed as (θ3, φ3), and the connection direction between the viewing reference point REF and the pixel at the lower leftmost corner of the display 110 can be expressed as (θ4, φ4). Therefore, the processor 150 selects the image IMG1 enclosed by the spherical coordinates (θ1, φ1), (θ2, φ2), (θ3, φ3), (θ4, φ4) from the full-view image IMG_sp to be displayed on the display 110.

In summary, the image display method, the image display system and the virtual window provided by embodiments of the invention, utilize a positioning device to determine the viewing direction that the user views the display, utilize an image capturing device located at the observation point to obtain an image corresponding to the viewing direction, and display the image on the display. Accordingly, it is capable of simulating the window view seen by the user who is located at the observation point.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. An image display system, comprising:
a first processor;
a display, coupled to the first processor and displaying a first image;
a positioning device, coupled to the first processor and determining a viewing direction according to a positional relationship between the display and a reference object; and
a first image capturing device, coupled to the first processor and capturing the first image according to the viewing direction and a position parameter.

2. The image display system as claimed in claim 1, wherein the first processor controls the first image capturing device to move to an observation point according to the positional relationship and the position parameter.

3. The image display system as claimed in claim 1, further comprising:
an input device, coupled to the first processor and configured to receive the position parameter.

4. The image display system as claimed in claim 1, wherein the first processor rotates the first image capturing device according to the viewing direction.

5. The image display system as claimed in claim 1, wherein the first image capturing device is a full-view camera and is configured to obtain a full-view image, and the first processor selects the first image corresponding to the viewing direction from the full-view image.

6. The image display system as claimed in claim 1, wherein the positioning device comprises:
a plurality of second image capturing devices, capturing a plurality of second images of different fields of view; and
a second processor, coupled to the second image capturing devices and analyzing the positional relationship according to the second images and calculating the viewing direction.

7. The image display system as claimed in claim 1, wherein the positioning device comprises:
a second image capturing device, configured to obtain a second image comprising the display;
a direction sensor, configured to obtain a current direction of the second image capturing device; and
a second processor, coupling to the second image capturing device and the direction sensor, and configured to calculate the viewing direction according to the second image and the current direction of the second image capturing device.

8. The image display system as claimed in claim 1, wherein the display comprises a plurality of pixels, and the viewing direction is a connection direction between a viewing reference point of the reference object and each of the pixels.

9. An image display method, applicable to an image display system comprising a display, a positioning device and a first image capturing device, the image display method comprising:
determining, by the positioning device, a viewing direction according to a positional relationship between the display and a reference object;
capturing, by the first image capturing device, a first image according to the viewing direction and a position parameter; and
displaying, by the display, the first image.

10. The image display method as claimed in claim 9, wherein the step of capturing, by the first image capturing device, the first image according to the viewing direction and the position parameter comprises:
controlling the first image capturing device to move to an observation point according to the positional relationship and the positional parameter.

11. The image display method as claimed in claim 9, further comprising:
receiving an input signal corresponding to the position parameter.

12. The image display method as claimed in claim 9, wherein the step of capturing, by the first image capturing device, the first image according to the viewing direction and the position parameter comprises:
rotating the first image capturing device according to the viewing direction.

13. The image display method as claimed in claim 9, wherein the step of capturing, by the first image capturing device, the first image according to the viewing direction and the position parameter comprises:
capturing, by the first image capturing device, a full-view image; and
selecting the first image corresponding to the viewing direction from the full-view image.

14. The image display method as claimed in claim 9, wherein the positioning device comprises a plurality of second image capturing devices, and the step of determining, by the positioning device, the viewing direction according to the positional relationship between the display and the reference object comprises:
capturing, by the second image capturing device, a plurality of second images in different fields of view; and
analyzing the positional relationship according to the second images and calculating the viewing direction.

15. The image display method as claimed in claim 9, wherein the positioning device comprises a second image capturing device, and the step of determining, by the positioning device, the viewing direction according to the positional relationship between the display and the reference object comprises:
capturing, by the second image capturing device, a second image comprising the display;
obtaining a current direction of the second image capturing device; and
calculating the viewing direction according to the second image and the current direction of the second image capturing device.

16. The image capturing device as claimed in claim 9, wherein the display comprises a plurality of pixels, and the viewing direction is a connection line between a viewing reference point of the reference object and each of the pixels.

17. A virtual window, configured to simulate a window view corresponding to an observation point, the virtual window comprising:
a first processor;
a display, coupled to the first processor and displaying a first image to simulate the window view;
a positioning device, coupled to the first processor and determining a viewing direction according to a positional relationship between the display and a reference object; and
a first image capturing device, coupled to the first processor and capturing the first image according to the viewing direction at the observation point.

18. The virtual window as claimed in claim 17, wherein the first processor controls the first image capturing device to move to the observation point.
